(19) United States
(12) Patent Application Publication
(10) Pub. No.: US 2025/0190721 A1
(43) Pub. Date: Jun. 12, 2025

(54) APPARATUS AND METHOD FOR MANAGING ARTIFICIAL INTELLIGENCE OPERATION BASED ON ANALOG DEVICE

(71) Applicant: ELECTRONICS AND TELECOMMUNICATIONS RESEARCH INSTITUTE, Daejeon (KR)

(72) Inventors: Chang-Dae KIM, Daejeon (KR); Kwang-Won Koh, Daejeon (KR); Tae-Hoon Kim, Daejeon (KR); Eun-Ji Pak, Daejeon (KR); Yeon-Jeong Jeong, Daejeon (KR)

(73) Assignee: ELECTRONICS AND ELECOMMUNICATIONS RESEARCH INSTITUTE, Daejeon (KR)

(21) Appl. No.: 18/971,225

(22) Filed: Dec. 6, 2024

(30) Foreign Application Priority Data
Dec. 8, 2023 (KR) 10-2023-0177824
Nov. 7, 2024 (KR) 10-2024-0156713

(51) Int. Cl. G06J 1/00

(52) U.S. Cl. CPC G06J 1/00

(57) ABSTRACT

Disclosed herein is an apparatus and method for managing an Artificial Intelligence (AI) operation based on an analog device. The method may include setting a first layer list to use an analog operation unit and analog memory based on a performance improvement effect obtained by using the analog operation unit, among layers constituting an AI model, setting a second layer list to use a digital operation unit and the analog memory based on a digital memory saving effect obtained by using the analog memory, among remaining layers excluding the first layer list from the layers constituting the AI model, and setting remaining layers excluding the first layer list and the second layer list from the layers constituting the AI model as a third layer list to use digital memory and the digital operation unit.

### CROSS REFERENCE TO RELATED APPLICATIONS

This application claims the benefit of Korean Patent Applications No. 10-2023-0177824, filed Dec. 8, 2023, and No. 10-2024-0156713, filed Nov. 7, 2024, which are hereby incorporated by reference in their entireties into this application.

### BACKGROUND OF THE INVENTION

### 1. Technical Field

The disclosed embodiment relates to technology for improving efficiency of Artificial Intelligence (AI) operations while managing accuracy in an AI accelerator including an analog operation unit.

### 2. Description of the Related Art

Analog computing represents numbers in a matrix as capacitance and stores the same in memory cells arranged in a lattice form. This is a computing technique for rapid operation of matrix-vector multiplication using a physical law that the current generated by applying voltages representing numbers in the vector to be multiplied by the matrix is equal to the product of the matrix and the vector according to Kirchihoff's current law.

Because matrix-vector multiplication is used as a key operation in AI and scientific computation, analog computing is receiving a lot of attention. Also, this is called computing-in-memory or processing-in-memory because an operation is performed directly in memory in which numbers in a matrix are stored.

Existing memory can represent one bit per memory cell, but in analog computing, a value of 4 to 8 bits can be represented and stored in a single cell because a number is represented as capacitance.

However, analog computing has problems that need to be solved.

First, a Digital-to-Analog Converter (DAC) for converting values in a matrix and input values represented as digital values into analog values and an Analog-to-Digital converter (ADC) for converting an operation result value represented as current into a digital value are required.

Particularly, the circuit size of an ADC is known to exponentially increase with the achievable resolution.

Also, the DAC and ADC cannot produce exact values like digital computing, and noise may be generated in the conversion process. Particularly, the ADC, which is required to convert a result value of matrix-vector multiplication, generates relatively more noise because it has to convert a number in a large range, compared to the DAC that converts input values or the values of matrix elements.

Also, in the case of analog computing, values in the form of capacitance are stored in memory cells. Accordingly, when drift occurs in a memory cell, the value contained in the memory cell also changes, so it is necessary to refresh the value in the memory cell.

Because a device that has an operation unit for performing digital computing, digital memory, and an analog computing operation unit can use a memory cell array in the analog computing operation unit as analog memory, the following four combinations of operations are possible.

TABLE 1

| | | | matrix-vector | number of memory | | |
|---|---|---|---|---|---|---|
| | | | multiplication | cells required for | computation | |
| | computing | memory | operation time | storing k bits | accuracy | remarks |
| 1 | digital | digital | O(N²) | k | high | |
| 2 | analog | digital | O(1) | k | medium | transfer to analog |
| | | | | | | memory is required |
| | | | | | | before operation |
| 3 | digital | analog | O(N²) | k/4~k/8 | medium | transfer to digital |
| | | | | | | memory is required |
| | | | | | | before operation |
| 4 | analog | analog | O(1) | k/4~k/8 | low | |

First, digital computing may be performed using values in digital memory. In this case, the matrix-vector multiplication operation takes O(N²) time, and k memory cells are required for storing k bits, but calculation may be accurately performed.

Second, analog computing may be performed using values in digital memory. In this case, the matrix-vector multiplication operation takes O(1) time, but additional O(N²) time is consumed because the values in the digital memory have to be transferred to the analog computing operation unit before the operation. Because matrix element values are stored in the digital memory, one memory cell is required for each bit. Also, noise is generated in the calculation. It is not practical because there is no advantage in terms of operation speed and accuracy.

Third, digital computing may be performed using analog memory. This is a method of transferring values input to memory cells in an analog memory to digital memory and performing an operation using a digital computing operation unit. Like digital computing, the matrix-vector multiplication operation takes O(N²) time, but because values are stored in analog memory and digital memory is only used temporarily, each memory cell may store about 4 to 8 bits. Also, although a drift effect may occur due to the use of analog memory, there is no computation noise because digital computing is used. Furthermore, because stored values are merely read, rather than being computed using analog computing, an ADC has low noise. This method has no advantage in terms of operation speed, but it can take advantage of the high integration density of analog memory and the high accuracy of digital computing.

Fourth, analog computing may be performed using values in analog memory. This is a method of performing analog computing using values input to memory cells in an analog memory. By utilizing analog computing, the matrix-vector multiplication operation takes O(1) time, and it has the advantage of being able to store a value of 4 to 8 bits in each memory cell. However, computation noise of analog computing and noise resulting from a drift effect may be generated.

An AI operation, which is one of representative applications of analog computing, is configured with multiple layers, and the result of one layer is often used as an input value of the subsequent layer.

Accordingly, when noise occurs in a result value due to the use of analog memory or analog computing, the noise is accumulated in subsequent layers that use the result value as input. Therefore, in order to manage the noise of the final result value to be below a certain level, it is necessary to determine the method of performing the operation considering the noise in all of the layers.

### SUMMARY OF THE INVENTION

An object of the disclosed embodiment is to improve the operation speed of an AI model by utilizing analog computing in a computing system capable of simultaneously utilizing a digital operation unit, digital memory, and an analog memory cell array including an analog operation unit.

Another object of the disclosed embodiment is to reduce memory requirements of an entire system in the computing system capable of simultaneously utilizing a digital operation unit, digital memory, and an analog memory cell array including an analog operation unit.

A further object of the disclosed embodiment is to maintain a decrease in the accuracy of an AI model, which is caused due to the use of analog computing and memory, below a user-desired level in a computing system capable of simultaneously utilizing a digital operation unit, digital memory, and an analog memory cell array including an analog operation unit.

Yet another object of the disclosed embodiment is to prevent a further decrease in accuracy caused due to drift of analog memory in a computing system capable of simultaneously utilizing a digital operation unit, digital memory, and an analog memory cell array including an analog operation unit.

A method for managing an Artificial Intelligence (AI) operation based on an analog device according to an embodiment may include setting a first layer list to use an analog operation unit and analog memory based on a performance improvement effect obtained by using the analog operation unit, among layers constituting an AI model, setting a second layer list to use a digital operation unit and the analog memory based on a digital memory saving effect obtained by using the analog memory, among remaining layers excluding the first layer list from the layers constituting the AI model, and setting remaining layers excluding the first layer list and the second layer list from the layers constituting the AI model as a third layer list to use digital memory and the digital operation unit.

Here, the method may further include performing profiling for each of the layers constituting the AI model before setting the first layer list, setting the second layers, and setting the remaining layers as the third layer, and performing the profiling may comprise measuring the performance improvement effect and the digital memory saving effect for each of the layers in advance.

Here, performing the profiling may include measuring inference performance and accuracy when all of the layers constituting the AI model use the digital operation unit and the digital memory, measuring inference performance and accuracy when only one of the layers constituting the AI model uses the analog memory, and measuring inference performance and accuracy when only one of the layers constituting the AI model uses the analog operation unit and the analog memory. Measuring the inference performance and the accuracy when using the analog memory and measuring the inference performance and the accuracy when using the analog operation unit and the analog memory may be repeatedly performed for each of the layers constituting the AI model.

Here, the method may further include, before setting the first layer list, setting a tolerance, which is an accuracy decrease tolerated by a user, and initializing a cumulative error inferred based on a profiling result for a combination of an operation unit and memory in the analog device.

Here, setting the first layer list may include selecting a layer that achieves a highest performance improvement effect by using the analog operation unit from among the layers constituting the AI model; and including the selected layer in the first layer list or a second phase list depending on whether the cumulative error updated by adding a previous cumulative error and an additional error caused due to the use of the analog operation unit by the selected layer is equal to or less than the tolerance, and setting the first layer list may be repeatedly performed for each of layers included in a first phase list.

Here, setting the second layer list may include selecting a layer that achieves a highest digital memory saving effect by using the analog memory from among remaining layers excluding the first layer list from the layers constituting the AI model; and including the selected layer in the second layer list when the cumulative error updated by adding the previous cumulative error and an additional error caused due to the use of the analog memory by the selected layer is equal to or less than the tolerance, and setting the second layer list may be repeatedly performed for each of layers included in the second phase list.

A method for managing an AI operation based on an analog device according to an embodiment may include, when an operation target layer of an AI model is set to use analog memory, checking the time elapsed after the corresponding layer is written to the analog memory; and refreshing the analog memory and determining to use a digital operation unit when the checked elapsed time is equal to or greater than a predetermined threshold value.

Here, the method may further include, when the checked elapsed time is less than the predetermined threshold value, determining to use the digital operation unit or analog operation unit set to be used for the corresponding layer.

Here, the method may further include, when the operation target layer is set to use digital memory in the AI model, determining to use the digital operation unit and digital memory set to be used for the corresponding layer.

An apparatus for managing an AI operation based on an analog device according to an embodiment includes an analog device, including a digital operation unit, digital memory, and an analog operation unit, and a control unit for controlling execution of an AI model in the analog device. The control unit may include a profiling unit for measuring in advance a performance improvement effect obtained by using the analog operation unit and a digital memory saving effect obtained by using analog memory for each of layers constituting the AI model, an operation-unit-memory optimal combination setting unit for setting one of a combination of the analog operation unit and the analog memory, a combination of the digital operation unit and the analog memory, and a combination of the digital operation unit and the digital memory as a combination to be used for each of the layers constituting the AI model, and an operation-unit-memory execution combination determination unit for determining a combination of an operation unit and memory to be executed in the analog device for each of the layers constituting the AI model based on a result of a previously set optimal combination of an operation unit and memory.

Here, the profiling unit may measure inference performance and accuracy when all of the layers constituting the AI model use the digital operation unit and the digital memory, measure inference performance and accuracy when only one of the layers constituting the AI model uses the analog memory, and measure inference performance and accuracy when only one of the layers constituting the AI model uses the analog operation unit and the analog memory. Measuring the inference performance and the accuracy when using the analog memory and measuring the inference performance and the accuracy when using the analog operation unit and the analog memory may be repeatedly performed for each of the layers constituting the AI model.

Here, the operation-unit-memory optimal combination setting unit may set a first layer list to use the analog operation unit and the analog memory based on the performance improvement effect obtained by using the analog operation unit, among the layers constituting the AI model, set a second layer list to use the digital operation unit and the analog memory based on the digital memory saving effect obtained by using the analog memory, among remaining layers excluding the first layer list from the layers constituting the AI model, and set remaining layers excluding the first layer list and the second layer list from the layers constituting the AI model as a third layer list to use the digital memory and the digital operation unit.

Here, the operation-unit-memory optimal combination setting unit may initialize a cumulative error inferred based on a profiling result for a combination of an operation unit and memory in the analog device before setting the first layer list.

Here, when setting the first layer list, the operation-unit-memory optimal combination setting unit may select a layer that achieves a highest performance improvement effect by using the analog operation unit from among the layers constituting the AI model and may include the selected layer in the first layer list or a second phase list depending on whether the cumulative error updated by adding a previous cumulative error and an additional error caused due to the use of the analog operation unit by the selected layer is equal to or less than a tolerance, and setting the first layer list may be repeatedly performed for each of layers included in a first phase list.

Here, the operation-unit-memory optimal combination setting unit may select a layer that achieves a highest digital memory saving effect by using the analog memory from among the remaining layers excluding the first layer list from the layers constituting the AI model and may include the selected layer in the second layer list when the cumulative error updated by adding the previous cumulative error and an additional error caused due to the use of the analog memory by the selected layer is equal to or less than the tolerance, and setting the second layer list may be repeatedly performed for each of layers included in the second phase list.

Here, the operation-unit-memory execution combination determination unit may check the time elapsed after an operation target layer of the AI model is written to the analog memory when the corresponding layer is set to use the analog memory, and may refresh the analog memory and determine to use the digital operation unit when the checked elapsed time is equal to or greater than a predetermined threshold value.

Here, when the checked elapsed time is less than the predetermined threshold value, the operation-unit-memory execution combination determination unit may determine to use the digital operation unit or analog operation unit set to be used for the corresponding layer.

Here, when the operation target layer is set to use the digital memory in the AI model, the operation-unit-memory execution combination determination unit may determine to use the digital operation unit and digital memory set to be used for the corresponding layer.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is an exemplary view of an analog device to which an embodiment is applied;

FIG. 2 is a schematic block diagram of an apparatus for managing an AI operation based on an analog device according to an embodiment;

FIG. 3 is a flowchart for explaining a method for managing an AI operation based on an analog device according to an embodiment;

FIG. 4 is a flowchart for explaining in detail a profiling step according to an embodiment;

FIGS. 5 and 6 are flowcharts for explaining in detail a step of searching for an optimal combination of an operation unit and memory according to an embodiment; and

FIG. 7 is a flowchart for explaining in detail a step of determining an execution combination of an operation unit and memory according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

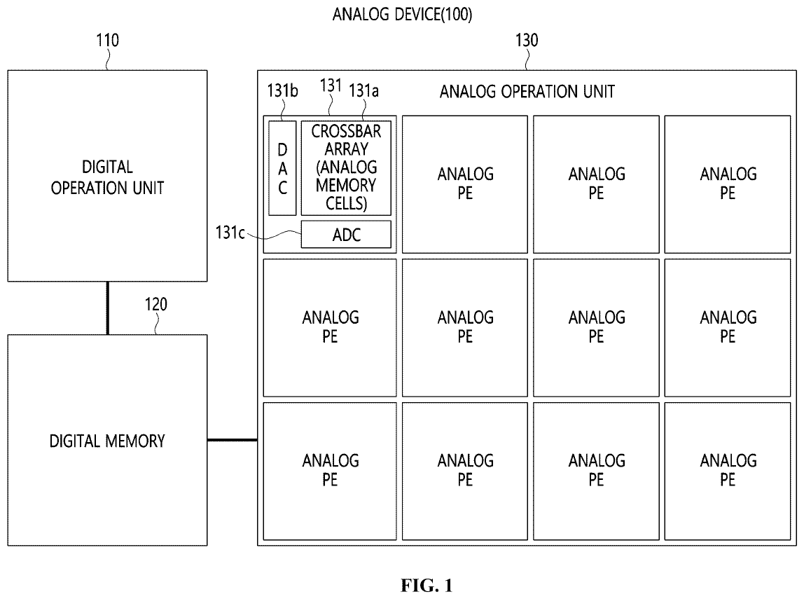

FIG. 1 is an exemplary view of an analog device to which an embodiment is applied.

Referring to FIG. 1, the analog device 100 according to an embodiment may include a digital operation unit 110, digital memory 120, and an analog operation unit 130.

Here, the digital operation unit 110 may be any of digital-based operation units, such as a CPU, a GPU, an NPU, and the like.

In the crossbar of the analog operation unit 130, only matrix-vector multiplication operations can be performed. Therefore, when a device is designed, the device includes a digital operation unit or a circuit for digital operations.

Also, memory cells in the analog operation unit 130 are usually used to store matrix element values, and because the write time is long, compared to DRAM and the like, buffers for storing input values or intermediate result values may be included in the form of digital memory. The digital memory 120 may encompass this.

Also, one or more Analog Processing Elements (APEs) 131 may be included in the analog operation unit 130.

Each of the Analog Processing Elements (APEs) 131 includes one or more crossbar arrays 131a, a Digital-to-Analog Converter (DAC) 131b, and an Analog-to-Digital Converter (ADC) 131c.

Here, the crossbar array 131a refers to analog memory cells configured in a lattice form.

The embodiment provides an apparatus and method for optimizing performance while maintaining the accuracy of an AI operation at a certain level based on the above-described analog device 100.

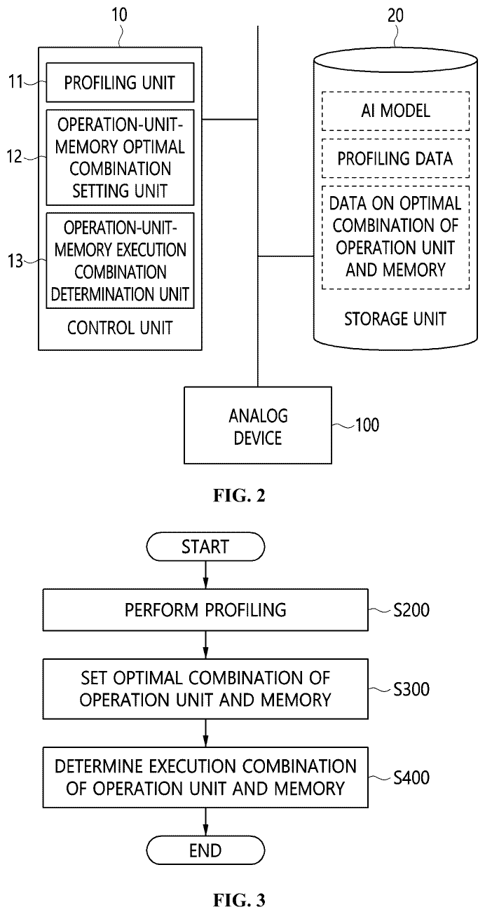

FIG. 2 is a schematic block diagram of an apparatus for managing an AI operation based on an analog device according to an embodiment.

Referring to FIG. 2, the apparatus for managing an AI operation based on an analog device may include an analog device 100 and a control unit 10 for controlling execution of an AI model in the analog device 100. Additionally, the apparatus for managing an AI operation based on an analog device may further include a storage unit 20.

Here, the control unit 10 may be implemented using various types of controllers, microprocessors, or general-purpose processors, which execute a program or processing instructions. Also, the control unit 10 may be configured such that the operation thereof is performed by the digital operation unit 110 of the analog device 100, rather than being separately configured as illustrated in FIG. 2.

The storage unit 20 may be a storage medium including at least one of a volatile medium, a nonvolatile medium, a detachable medium, a non-detachable medium, a communication medium, or an information delivery medium, or a combination thereof. Also, the storage unit 20 may be configured such that the functions thereof are performed by the digital memory 120 of the analog device 100, rather than being separately configured as illustrated in FIG. 2.

According to an embodiment, the control unit 10 may include a profiling unit 11, an operation-unit-memory optimal combination setting unit 12, and an operation-unit-memory execution combination determination unit 13.

The profiling unit 11 measures in advance the performance improvement effect obtained by using the analog operation unit and the digital memory saving effect obtained by using the analog memory for each of layers constituting the AI model.

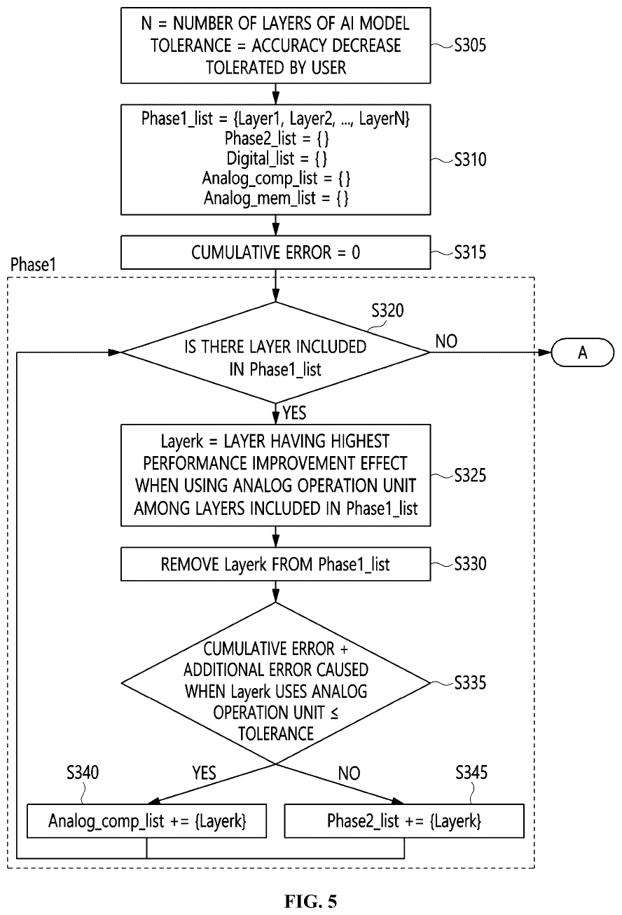

Here, profiling data generated by the profiling unit 11 may be stored in the storage unit 20. The detailed operation of the profiling unit 11 will be described later with reference to FIG. 4.

The operation-unit-memory optimal combination setting unit 12 sets one of a combination of the analog operation unit and the analog memory, a combination of the digital operation unit and the analog memory, and a combination of the digital operation unit and the digital memory as the combination to be used for each of the layers constituting the AI model.

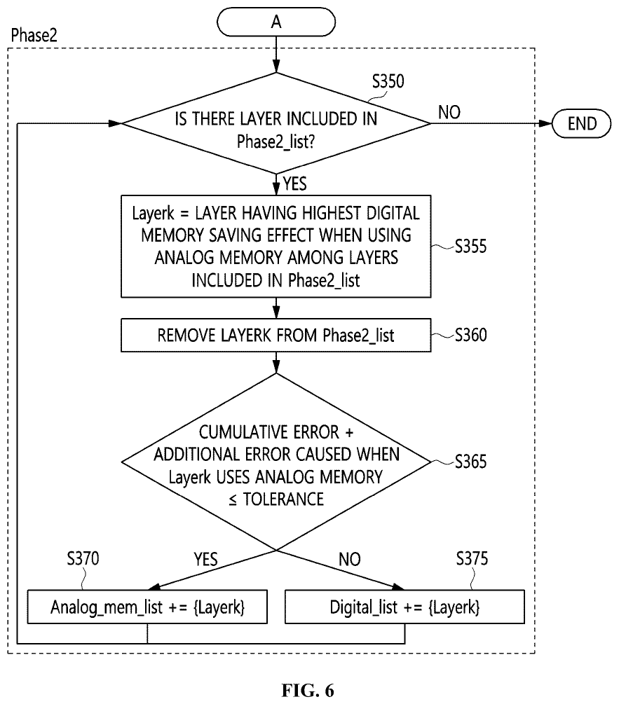

Here, data on the optimal combination of the operation unit and the memory for each of the layers constituting the AI model, which is set by the operation-unit-memory optimal combination setting unit 12, may be stored in the storage unit 20. The detailed operation of the operation-unit-memory optimal combination setting unit 12 will be described later with reference to FIGS. 5 and 6.

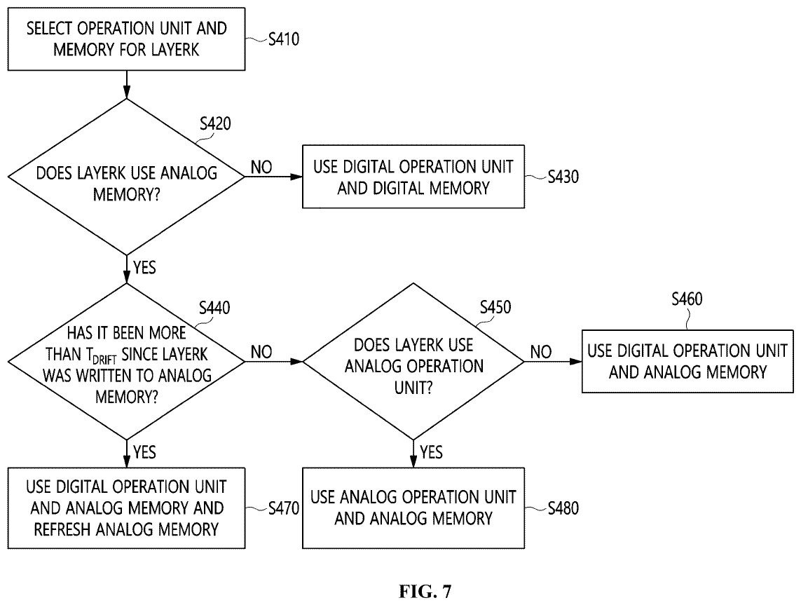

The operation-unit-memory execution combination determination unit 13 may determine a combination of the operation unit and memory to be executed for each of the layers constituting the AI model in the analog device based on the previously set optimal combination of the operation unit and the memory. The detailed operation of the operation-unit-memory execution combination determination unit 13 will be described later with reference to FIG. 7.

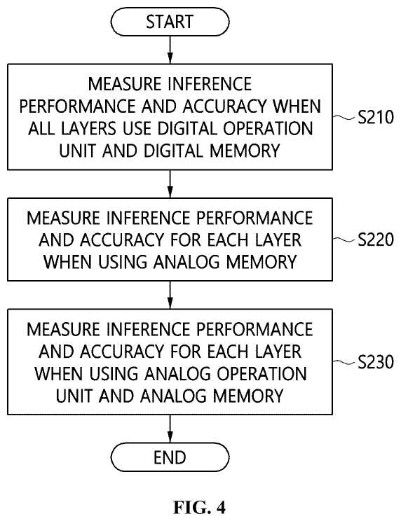

FIG. 3 is a flowchart for explaining a method for managing an AI operation based on an analog device according to an embodiment.

Referring to FIG. 3, the method for managing an AI operation based on an analog device according to an embodiment may include a profiling step S200 (FIG. 4) for measuring in advance a performance improvement effect obtained by using an analog operation unit and a digital memory saving effect obtained by using analog memory for each of layers constituting an AI model, an operation-unit-memory optimal combination setting step S300 (FIGS. 6 and 7) for setting one of a combination of an analog operation unit and analog memory, a combination of a digital operation unit and analog memory, and a combination of a digital operation unit and digital memory as the combination to be used for each of the layers constituting the AI model, and an operation-unit-memory execution combination determination step S400 (FIG. 8) for determining a combination of the operation unit and memory to be executed for each of the layers constituting the AI model in the analog device based on the previously set optimal combination of the operation unit and memory.

FIG. 4 is a flowchart for explaining in detail a profiling step according to an embodiment.

Referring to FIG. 4, the profiling step S200 according to an embodiment may include measuring inference performance and accuracy when all layers constituting an AI model use a digital operation unit and digital memory at step S210, measuring inference performance and accuracy when only one of the layers constituting the AI model uses analog memory at step S220, and measuring inference performance and accuracy when only one of the layers constituting the AI model uses an analog operation unit and the analog memory at step S230.

First, at step S210 according to an embodiment, the profiling unit 11 stores the parameters of all of the layers of the AI model in the digital memory and measures the speed of AI inference using the digital operation unit and the accuracy for the test set of input values.

Subsequently, at step S220 according to an embodiment, the profiling unit 11 measures the speed of AI inference and the accuracy for the test set of input values in an environment in which, for one of the layers of the AI model, the parameters thereof are stored in the analog memory and the digital operation unit is used for the operation, while for all of the remaining layers, the parameters thereof are stored in the digital memory and the digital operation unit is used.

Here, the profiling unit 11 performs step S220 once for each of the layers of the AI model.

Finally, at step S230 according to an embodiment, the profiling unit 11 measures the speed of AI inference and the accuracy for the test set of input values in an environment in which, for one of the layers of the AI model, the parameters thereof are stored in the analog memory and the analog operation unit is used for the operation, while for all of the remaining layers, the parameters thereof are stored in the digital memory and the digital operation unit is used.

Here, the profiling unit 11 performs step S230 once for each of the layers of the AI model.

By performing the above-described profiling step S200, it is possible to obtain the inference performance and accuracy when all the layers use the digital operation unit and the digital memory, the inference performance and accuracy when only a specific layer uses the analog memory, and the inference performance and accuracy when only a specific layer uses the analog operation unit and the analog memory.

Accordingly, when an analog device is used, there are three options for each of the layers of the AI model.

That is, the digital operation unit and the digital memory can be used, the digital operation unit and the analog memory can be used in order to only save memory capacity, and the analog operation unit and the analog memory can be used in order to save the memory capacity and improve the performance.

However, 3^{N} cases are possible when there are N layers, and all of the cases have different accuracy. Accordingly, it is not easy to find an optimal combination.

Therefore, the operation-unit-memory optimal combination setting step S300 is performed in the method for managing an AI operation based on an analog device according to an embodiment.

FIGS. 5 and 6 are flowcharts for explaining in detail a step of searching for the optimal combination of an operation unit and memory according to an embodiment.

Referring to FIGS. 5 and 6, the optimal combination search step S300 according to an embodiment may include setting a first layer list to use an analog operation unit and analog memory based on a performance improvement effect obtained by using the analog operation unit, among layers constituting an AI model, at steps S320 to S340, setting a second layer list to use a digital operation unit and the analog memory based on a digital memory saving effect obtained by using the analog memory, among the remaining layers excluding the first layer list from the layers constituting the AI model, at steps S345 to S370, setting the remaining layers excluding the first layer list and the second layer list from the layers constituting the AI model as a third layer list to use digital memory and the digital operation unit at step S375.

That is, through the optimal combination search step S300 according to an embodiment, the combination for executing each of the layers of the AI model is selected from among the combination of the digital operation unit and the digital memory, the combination of the digital operation unit and the analog memory, and the combination of the analog operation unit and the analog memory.

In the example illustrated in FIGS. 5 and 6, it is assumed that the number of layers of the AI model is N at step S305.

Also, an accuracy decrease tolerance specified by a user is referred to as a ‘tolerance’, and an error inferred based on a profiling result for the combination that is set by searching for the optimal combination is referred to as a ‘cumulative error’.

Referring to FIGS. 5 and 6, the optimal combination search step S300 according to an embodiment includes two phases, and Phase1_list and Phase2_list are used for the two phases.

Also, the first layer list (referred to as “Analog_comp_list” hereinbelow) to contain the layers determined to use the analog operation unit and the analog memory, the second layer list (referred to as “Analog_mem_list” hereinbelow) to contain the layers determined to use the digital operation unit and the analog memory, and the third layer list (referred to as “Digital_list” hereinbelow) to contain the layers determined to use the digital operation unit and the digital memory are also used at step S310.

First, the operation-unit-memory optimal combination setting unit 12 (referred to as the “optimal combination setting unit” hereinbelow) includes all of the layers in Phase1_list and sets the cumulative error to 0 at step S315.

Here, setting the cumulative error to 0 indicates that all layers are assumed to basically use the digital operation unit and the digital memory.

The phase illustrated in FIG. 5 (Phase 1) aims to determine the layers to use the analog operation unit and the analog memory in order to achieve both performance improvement and digital memory saving.

To this end, the optimal combination setting unit 12 first selects the layer that achieves the highest performance improvement effect when using the analog operation unit from Phase1_list at step S325 and then removes the selected layer from Phase1_list at step S330.

Here, the performance improvement and the decrease in accuracy when executing the layer in the analog operation unit can be seen based on the profiling data generated at step S200 described above.

Subsequently, the optimal combination setting unit 12 determines at step S335 whether the cumulative error is equal to or less than the tolerance even though the layer is executed in the analog operation unit.

When it is determined at step S335 that the cumulative error is equal to or less than the tolerance, the optimal combination setting unit 12 includes the corresponding layer in Analog_comp_list at step S340.

Conversely, when it is determined at step S335 that the cumulative error is greater than the tolerance, the optimal combination setting unit 12 includes the corresponding layer in Phase2_list at step S345.

Steps S320 to S345 described above are repeatedly performed until there is no layer remaining in Phase1_list. That is, the optimal combination setting unit 12 performs steps S320 to S345 for all of the layers that constitute the AI model.

In Phase 1 described above, the layer selected and removed from Phase1_list is not put into Phase1_list again. Accordingly, once all of the layers are explored, Phase1_list becomes empty and Phase 1 is terminated.

After termination of Phase 1, the layers that use the analog operation unit and the analog memory are included in Analog_comp_list, and the remaining layers are included in Phase2_list.

In the second phase (Phase 2), it is checked whether accuracy is maintained above a permissible level even though the layers determined not to use the analog operation unit use the analog memory in order to save the digital memory, whereby as many layers as possible are set to use the analog memory.

That is, referring to FIG. 6, because the layers determined not to use the digital operation unit in Phase 1 are contained in Phase2_list, the optimal combination setting unit 12 considers the layers contained in Phase2_list in Phase 2.

Specifically, the optimal combination setting unit 12 selects the layer that achieves the highest digital memory saving effect when transferred to the analog memory from among the layers contained in Phase2_list at step S355 and removes the selected layer from Phase2_list at step S360.

Subsequently, the optimal combination setting unit 12 checks at step S365 whether the cumulative error when transferring the layer to the analog memory is equal to or less than the tolerance.

When it is determined at step S365 that the cumulative error is equal to or less than the tolerance, the optimal combination setting unit 12 includes the corresponding layer in Analog_mem_list, thereby setting the corresponding layer to use the analog memory and the digital operation unit at step S370.

Conversely, when it is determined at step S365 that the cumulative error is greater than the tolerance, the optimal combination setting unit 12 includes the corresponding layer in Digital_list, thereby setting the corresponding layer to use the digital memory and the digital operation unit at step S375.

Steps S350 to S375 described above are repeated until there is no layer remaining in Phase2_list. That is, these steps are repeated until all of the layers are removed from Phase2_list and moved to Analog_mem_list or Digital_list.

When the optimal combination search step S300 described above is terminated, the layers determined to use the analog operation unit and the analog memory are included in Analog_comp_list, the layers determined to use the digital operation unit and the analog memory are included in Analog_mem_list, and the layers determined to use the digital operation unit and the digital memory are included in Digital_list. Also, when the AI model is executed using the operation unit and memory set by the optimal combination search step S300, the estimated cumulative error may be less than the tolerance.

Hereinafter, the step (S400) of selecting the operation unit and memory to be used for each layer when inference using the AI model is performed will be described.

The operation-unit-memory execution combination determination unit 13 (referred to as the “execution combination determination unit” hereinbelow) according to an embodiment may perform step S400 each time the operation for each layer is initiated when inference is performed.

FIG. 7 is a flowchart for explaining in detail a step of determining an execution combination of an operation unit and memory according to an embodiment.

Referring to FIG. 7, the execution combination determination unit 13 selects the operation unit and memory set for the current operation target layer in the AI model at step S410.

That is, in the result of the above-described optimal combination search step S300, the layers included in Analog_comp_list or Analog_mem_list are layers set to use the analog memory, and the layers included in Digital_list are layers set not to use the analog memory.

Subsequently, the execution combination determination unit 13 determines at step S420 whether the operation target layer is set to use the analog memory.

When it is determined at step S420 that the operation target layer is set to use the digital memory, it also uses the digital operation unit, so the execution combination determination unit 13 determines at step S430 that the operation for the corresponding layer is performed using the digital operation unit and the digital memory.

Conversely, when it is determined at step S420 that the operation target layer is set to use the analog memory, the execution combination determination unit 13 calculates the time elapsed after the corresponding layer is written to the analog memory in order to consider a drift effect and then determines whether the elapsed time is equal to or greater than a predetermined threshold value at step S440.

When it is determined at step S440 that the elapsed time is less than the predetermined threshold value, the execution combination determination unit 13 determines whether to use the analog operation unit depending on the value set in the optimal combination search method at step S450.

That is, when the layer is a layer included in Analog_comp_list, the analog operation unit and the analog memory are used at step S480, and when the layer is a layer included in Analog_mem_list, the value in the analog memory is transferred to the digital memory and the digital operation unit is used at step S460.

When it is determined at step S440 that the elapsed time is equal to or greater than the predetermined threshold value, the execution combination determination unit 13 determines to perform the operation using the digital operation unit for the corresponding layer simultaneously with performing the refresh of the analog memory at step S470.

That is, the layer stored in the analog memory and required to perform the refresh is made to use the digital operation unit for the following reason.

In order to perform the refresh, it is required to read values from the analog memory, transfer the values to the digital memory, read the values from the digital memory again, and write the values to the analog memory. However, in this process, an ADC is used when reading the values from the analog memory, and a DAC is used when writing the values to the analog memory, so the analog operation cannot be performed. That is, the refresh and the analog operation have to be performed sequentially. However, after the values are transferred to the digital memory, the operation can be performed immediately through the digital operation unit, and this may be performed simultaneously with the process of reading from the digital memory for writing the values back to the analog memory. Therefore, it is more efficient to perform the operation using the digital operation unit while the values are being written to the analog memory again.

For the corresponding layer, a refresh task through which it is transferred to the digital memory and then written back to the analog memory has to be performed. In an embodiment, when the layer is transferred to the digital memory in order to perform the refresh task, the operation is performed through the digital operation unit. During the refresh operation, the ADC is used to read values from the analog memory, so the analog operation unit cannot be used. Therefore, in order to use the analog operation unit, the values have to be written to the analog memory again, and then the operation may be performed. Therefore, after the values are transferred to the digital memory, it is more efficient to perform the operation using the digital operation unit while the values are written back to the analog memory.

According to the disclosed embodiment, the operation speed of an AI model may be improved using analog computing in a computing system capable of simultaneously utilizing a digital operation unit, digital memory, and an analog memory cell array including an analog operation unit.

According to the disclosed embodiment, memory requirements of an entire system may be reduced in the computing system capable of simultaneously utilizing a digital operation unit, digital memory, and an analog memory cell array including an analog operation unit.

According to the disclosed embodiment, a decrease in the accuracy of an artificial intelligence model, which is caused due to the use of analog computing and memory, may be maintained below a user-desired level in a computing system capable of simultaneously utilizing a digital operation unit, digital memory, and an analog memory cell array including an analog operation unit.

According to the disclosed embodiment, a further decrease in accuracy, which is caused due to drift of analog memory, may be prevented in a computing system capable of simultaneously utilizing a digital operation unit, digital memory, and an analog memory cell array including an analog operation unit.

What is claimed is:

1. A method for managing an Artificial Intelligence (AI) operation based on an analog device, comprising:
setting a first layer list to use an analog operation unit and analog memory based on a performance improvement effect obtained by using the analog operation unit, among layers constituting an AI model;
setting a second layer list to use a digital operation unit and the analog memory based on a digital memory saving effect obtained by using the analog memory, among remaining layers excluding the first layer list from the layers constituting the AI model; and
setting remaining layers excluding the first layer list and the second layer list from the layers constituting the AI model as a third layer list to use digital memory and the digital operation unit.

2. The method of claim 1, further comprising:
performing profiling for each of the layers constituting the AI model before setting the first layer list, setting the second layer list, and setting the remaining layers as the third layer list,
wherein
performing the profiling comprises measuring the performance improvement effect and the digital memory saving effect for each of the layers in advance.

3. The method of claim 2, wherein
performing the profiling comprises
measuring inference performance and accuracy when all of the layers constituting the AI model use the digital operation unit and the digital memory,
measuring inference performance and accuracy when only one of the layers constituting the AI model uses the analog memory, and
measuring inference performance and accuracy when only one of the layers constituting the AI model uses the analog operation unit and the analog memory, and
measuring the inference performance and the accuracy when using the analog memory and measuring the inference performance and the accuracy when using the analog operation unit and the analog memory are repeatedly performed for each of the layers constituting the AI model.

4. The method of claim 1, further comprising:
before setting the first layer list,
setting a tolerance that is an accuracy decrease tolerated by a user; and
initializing a cumulative error inferred based on a profiling result for a combination of an operation unit and memory in the analog device.

5. The method of claim 4, wherein
setting the first layer list comprises
selecting a layer that achieves a highest performance improvement effect by using the analog operation unit from among the layers constituting the AI model; and
including the selected layer in the first layer list or a second phase list depending on whether the cumulative error updated by adding a previous cumulative error and an additional error caused due to use of the analog operation unit by the selected layer is equal to or less than the tolerance, and
setting the first layer list is repeatedly performed for each of layers included in a first phase list.

6. The method of claim 5, wherein
setting the second layer list comprises
selecting a layer that achieves a highest digital memory saving effect by using the analog memory from among the remaining layers excluding the first layer list from the layers constituting the AI model; and
including the selected layer in the second layer list when the cumulative error updated by adding a previous cumulative error and an additional error caused due to use of the analog memory by the selected layer is equal to or less than the tolerance, and
setting the second layer list is repeatedly performed for each of layers included in the second phase list.

7. A method for managing an Artificial Intelligence (AI) operation based on an analog device, comprising:
when an operation target layer of an AI model is set to use analog memory, checking time elapsed after the corresponding layer is written to the analog memory; and
when the checked elapsed time is equal to or greater than a predetermined threshold value, refreshing the analog memory and determining to use a digital operation unit.

8. The method of claim 7, further comprising:
when the checked elapsed time is less than the predetermined threshold value, determining to use the digital operation unit or analog operation unit set to be used for the corresponding layer.

9. The method of claim 7, further comprising:
when the operation target layer is set to use digital memory in the AI model, determining to use the digital operation unit and digital memory set to be used for the corresponding layer.

10. An apparatus for managing an Artificial Intelligence (AI) operation based on an analog device, comprising:
an analog device including a digital operation unit, digital memory, and an analog operation unit; and
a control unit for controlling execution of an AI model in the analog device,
wherein the control unit includes
a profiling unit for measuring in advance a performance improvement effect obtained by using the analog operation unit and a digital memory saving effect obtained by using analog memory for each of layers constituting the AI model,
an operation-unit-memory optimal combination setting unit for setting one of a combination of the analog operation unit and the analog memory, a combination of the digital operation unit and the analog memory, and a combination of the digital operation unit and the digital memory as a combination to be used for each of the layers constituting the AI model, and
an operation-unit-memory execution combination determination unit for determining a combination of an operation unit and memory to be executed in the analog device for each of the layers constituting the AI model based on a result of a previously set optimal combination of an operation unit and memory.

11. The apparatus of claim 10, wherein
the profiling unit measures inference performance and accuracy when all of the layers constituting the AI model use the digital operation unit and the digital memory, measures inference performance and accuracy when only one of the layers constituting the AI model uses the analog memory, and measures inference performance and accuracy when only one of the layers constituting the AI model uses the analog operation unit and the analog memory, and
measuring the inference performance and the accuracy when using the analog memory and measuring the inference performance and the accuracy when using the analog operation unit and the analog memory are repeatedly performed for each of the layers constituting the AI model.

12. The apparatus of claim 10, wherein the operation-unit-memory optimal combination setting unit sets a first layer list to use the analog operation unit and the analog memory based on the performance improvement effect obtained by using the analog operation unit, among the layers constituting the AI model, sets a second layer list to use the digital operation unit and the analog memory based on the digital memory saving effect obtained by using the analog memory, among remaining layers excluding the first layer list from the layers constituting the AI model, and sets remaining layers excluding the first layer list and the second layer list from the layers constituting the AI model as a third layer list to use the digital memory and the digital operation unit.

13. The apparatus of claim 12, wherein the operation-unit-memory optimal combination setting unit initializes a cumulative error inferred based on a profiling result for a combination of an operation unit and memory in the analog device before setting the first layer list.

14. The apparatus of claim 13, wherein
when setting the first layer list, the operation-unit-memory optimal combination setting unit selects a layer that achieves a highest performance improvement effect by using the analog operation unit from among the layers constituting the AI model and includes the selected layer in the first layer list or a second phase list depending on whether the cumulative error updated by adding a previous cumulative error and an additional error caused due to use of the analog operation unit by the selected layer is equal to or less than a tolerance, and
setting the first layer list is repeatedly performed for each of layers included in a first phase list.

15. The apparatus of claim 14, wherein
the operation-unit-memory optimal combination setting unit selects a layer that achieves a highest digital memory saving effect by using the analog memory from among the remaining layers excluding the first layer list from the layers constituting the AI model and includes the selected layer in the second layer list when the cumulative error updated by adding a previous cumulative error and an additional error caused due to use of the analog memory by the selected layer is equal to or less than the tolerance, and
setting the second layer list is repeatedly performed for each of layers included in the second phase list.

16. The apparatus of claim 10, wherein the operation-unit-memory execution combination determination unit checks time elapsed after an operation target layer of the AI model is written to the analog memory when the corresponding layer is set to use the analog memory, and refreshes the analog memory and determines to use the digital operation unit when the checked elapsed time is equal to or greater than a predetermined threshold value.

17. The apparatus of claim 16, wherein, when the checked elapsed time is less than the predetermined threshold value, the operation-unit-memory execution combination determination unit determines to use the digital operation unit or analog operation unit set to be used for the corresponding layer.

18. The apparatus of claim 17, wherein, when the operation target layer is set to use the digital memory in the AI model, the operation-unit-memory execution combination determination unit determines to use the digital operation unit and digital memory set to be used for the corresponding layer.
